(19) United States
(12) Patent Application Publication
(10) Pub. No.: US 2025/0385571 A1
(43) Pub. Date: Dec. 18, 2025

(54) MODULAR ACTUATOR

(71) Applicant: Honeywell International Inc., Charlotte, NC (US)

(72) Inventors: Jason L. Ableitner, Edina, MN (US); Michael Li, Tianjin (CN); Per Thomas Bertilsson, Fribourg (SE); ShaoHui Wu, Tianjin (CN); Si Chao Liu, Tianjin (CN); Timm E. Hartman, Gilbert, AZ (US); Zhi Xiong Wang, Tianjin (CN); Yun Zhi Liu, Tianjin (CN); YuZhou Xu, Tianjin (CN)

(21) Appl. No.: 18/879,353

(22) PCT Filed: Jun. 28, 2022
(86) PCT No.: PCT/CN2022/101808

§ 371 Date: Dec. 27, 2024

(51) Int. Cl. H02K 7/116; F16H 1/02; F16H 19/02; H02K 15/50

(52) U.S. Cl. CPC H02K 7/116; F16H 1/02; F16H 19/02; H02K 15/50; H02K 2213/12

(57) ABSTRACT

A modular actuator may include a modular actuator base assembly and a modular control assembly. Each of the modular actuator base assembly and the modular control assembly may be selected from a plurality of different modular actuator base assemblies, and a plurality of different modular control assemblies in order to provide an appropriate functionality for a particular application. One or more of the modular actuator base assembly and the modular controller assembly may be field-replaceable, in order to provide additional functionality to an installed modular actuator.

The present application claims priority to PCT International Application No. PCT/CN2022/101808, filed on Jun. 28, 2022, entitled “MODULAR ACTUATOR”, which is incorporated herein by reference.

### TECHNICAL FIELD

The present disclosure pertains generally to actuators and more particularly to modular actuators assembled from modular actuator components.

### BACKGROUND

Actuators are used in a number of different applications that potentially require significant differences in design, such as motor size, motor torque, gear train reduction gearing, and/or actuator output type (e.g. linear or rotary). Actuators can also have differences in how a particular actuator is controlled. For example, some actuator controllers are configured to provide additional functionality beyond simply opening or closing a valve or damper. Some actuator controllers simply receive control commands and control the actuator according to the received control commands. Some actuator controllers are configured to receive one or more sensor inputs and control the actuator in accordance with the one or more sensor inputs. Some actuator controllers are configured to provide communications capability with one or more communication networks.

Providing actuators that are customized for a particular application can mean needing a large number of different actuators SKU's that may vary by one or more of motor size, motor torque, gear train performance, actuator output type, control features and/or communication capability. As control systems are modernized, this can require actuator replacement when the existing actuator does not have the necessary functionality. What would be beneficial are improved modular actuators that can be assembled, sometimes in the field, from combinations of modular components. What would be beneficial are improved modular actuators that can be upgraded in the field by simply replacing one or more modules to provide desired or upgraded functionality.

### SUMMARY

This disclosure relates generally to improved modular actuators that can be assembled, sometimes in the field, from combinations of modules each providing one or more functions of an actuator, as well as improved modular actuators that can be upgraded in the field by simply replacing one or more modules to provide a desired functionality.

In one example, a modular actuator may include a modular actuator driver assembly, a modular actuator assembly and a modular controller assembly. Each of the modular actuator driver assembly, the modular actuator assembly and the modular controller assembly may be selected from a plurality of different modular actuator driver assemblies, a plurality of different modular actuation assemblies and a plurality of different modular controller assemblies in order to provide a desired functionality for a particular application. One or more of the modular actuator driver assembly, the modular actuator assembly and the modular controller assembly may be field-replaceable, in order to provide additional and/or different functionality to an installed modular actuator.

An example may be found in a modular actuator that is configurable in the field, meaning subsequent to manufacture and when installation may be imminent. The illustrative modular actuator includes a first modular actuator driver assembly, the first modular actuator driver assembly including a first electric motor operatively coupled to a first gear train, wherein the first gear train includes two or more reduction gears for driving a drive output of the first modular actuator driver assembly. The first electric motor and the first gear train are carried by a first actuator driver assembly housing that exposes the drive output. The illustrative modular actuator includes a first modular actuator assembly, the first modular actuator assembly providing the actuator output of the modular actuator. The first modular actuator assembly includes a second gear train, wherein the second gear train includes two or more reduction gears for driving the actuator output. The second gear train and the actuator output are carried by a first actuator assembly housing. The first actuator assembly housing is removably mountable to the first actuator driver assembly housing in the field such the second gear train of the first modular actuator assembly is operatively coupled to and driven by the exposed drive output of the first modular actuator driver assembly. The illustrative modular actuator further includes a first modular controller assembly. The first modular controller assembly includes a first controller housed by a first controller housing, where the first controller housing is removably mountable to the first actuator driver assembly housing and/or the first actuator assembly housing in the field. The first controller of the first modular controller assembly is configured to control the first electric motor of the first modular actuator driver assembly, and thus control the actuator output of the modular actuator through the first gear train and the second gear train.

Another example may be found in a modular actuator that is configured to drive an actuator output. The illustrative modular actuator includes a first modular actuator driver assembly. The first modular actuator driver assembly including a first electric motor operatively coupled to a first gear train, wherein the first gear train includes two or more reduction gears for driving a drive output of the first modular actuator driver assembly. The first electric motor and first gear train are carried by a first actuator driver assembly housing that exposes the drive output. The illustrative modular actuator further includes a first modular actuator assembly. The first modular actuator assembly provides the actuator output of the modular actuator. The first modular actuator assembly includes a second gear train, wherein the second gear train includes two or more reduction gears for driving the actuator output. The second gear train and the actuator output are carried by a first actuator assembly housing. The first actuator assembly housing is removably mountable to the first actuator driver assembly housing such the second gear train of the first modular actuator assembly is operatively coupled to and driven by the exposed drive output of the first modular actuator driver assembly. The illustrative modular actuator further includes a first modular controller assembly. The first modular controller assembly includes a first controller housed by a first controller housing. The first controller housing is removably mountable to the first actuator driver assembly housing and/or the first actuator assembly housing, wherein the first controller of the first modular controller assembly is configured to control the first electric motor of the first modular actuator driver assembly, and thus control the actuator output of the modular actuator through the first gear train and the second gear train.

In some cases, at least one of the first modular actuator driver assembly and the first modular actuator assembly includes one or more circuit elements that, when interrogated, identify one or more configuration parameters of the corresponding modular assembly. In this example, the first modular controller assembly is configured to interrogate one or more of the circuit elements to identify one or more of the configuration parameters of the corresponding modular assembly, and control the first electric motor of the first modular actuator driver assembly based at least in part on the one or more identified configuration parameters.

Another example may be found in a method for assembling a modular actuator having an actuator output. The illustrative method includes selecting a first modular actuator driver assembly from a plurality of modular actuator driver assemblies. The first modular actuator driver assembly including a first electric motor operatively coupled to a first gear train, wherein the first gear train includes two or more reduction gears for driving a drive output of the first modular actuator driver assembly. The first electric motor and first gear train are carried by a first actuator driver assembly housing that exposes the drive output. A first modular actuator assembly is selected from a plurality of modular actuator assemblies. The first modular actuator assembly provides the actuator output of the modular actuator. The first modular actuator assembly includes a second gear train, wherein the second gear train includes two or more reduction gears for driving the actuator output, the second gear train and the actuator output are carried by a first actuator assembly housing. The first actuator assembly housing is mounted to the first actuator driver assembly housing such the second gear train of the first modular actuator assembly is operatively coupled to and driven by the exposed drive output of the first modular actuator driver assembly. A first modular controller assembly is selected from a plurality of modular controller assemblies. The first modular controller assembly includes a first controller housed by a first controller housing. The first controller housing is mounted to the first actuator driver assembly housing and/or the first actuator assembly housing, wherein the first controller of the first modular controller assembly is configured to control the first electric motor of the first modular actuator driver assembly, and thus control the actuator output of the modular actuator, through the first gear train and the second gear train.

Another example may be found in a modular actuator that is configurable in the field and is configured to drive an actuator output. The modular actuator includes a first modular actuator base assembly that provides the actuator output of the modular actuator, and a first modular control assembly. The first modular actuator base assembly includes a first modular actuator base housing, and a first electric motor operatively coupled to a first gear train, wherein the first gear includes two or more reduction gears for driving the actuator output. The first electric motor and the first gear train are carried by the first modular actuator base housing. The first modular control assembly includes a first control assembly housing and a first controller carried by the first control assembly housing. The first control assembly housing is removable mountable to the first modular actuator base housing in the field. The first controller is configured to control the first electric motor of the first modular actuator base assembly, and thus control the actuator output of the modular actuator through the first gear train.

Another example may be found in a modular actuator that is configured to drive an actuator output. The modular actuator includes a first modular actuator base assembly that provides the actuator output of the modular actuator, and a first modular control assembly. The first modular actuator base assembly includes a first modular actuator base housing, and a first electric motor operatively coupled to a first gear train, wherein the first gear includes two or more reduction gears for driving the actuator output. The first electric motor and the first gear train are carried by the first modular actuator base housing. The first modular control assembly includes a first control assembly housing and a first controller carried by the first control assembly housing. The first control assembly housing is removable mountable to the first modular actuator base housing in the field. The first controller is configured to control the first electric motor of the first modular actuator base assembly, and thus control the actuator output of the modular actuator through the first gear train. The first modular actuator base assembly includes one or more circuit elements that when interrogated identify one or more configuration parameters of the first modular actuator base assembly, and wherein the first modular control assembly is configured to interrogate one or more of the circuit elements to identify one or more of the configuration parameters and control the first electric motor of the first modular actuator base assembly, and thus control the actuator output of the modular actuator, based at least in part on the one or more identified configuration parameters.

Another example may be found in a method for assembling a modular actuator having an actuator output. The method includes selecting a first modular actuator base assembly from a plurality of modular actuator base assemblies. The first modular actuator base assembly including a first electric motor operatively coupled to a first gear train, wherein the first gear train includes two or more reduction gears for driving an actuator output of the first modular actuator base assembly, and wherein the first electric motor and first gear train are carried by a first modular actuator base housing. A first modular control assembly is selected from a plurality of modular control assemblies. The first modular control assembly includes a first controller housed by a first modular controller assembly housing. The first modular controller assembly housing is removably mounted to the first modular actuator base housing, wherein the first controller of the first modular control assembly is configured to control the first electric motor of the first modular actuator base assembly, and thus control the actuator output of the first modular actuator base assembly.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative modular actuator;

FIG. 2 is a schematic block diagram of an illustrative modular actuator driver assembly forming part of the illustrative modular actuator of FIG. 1;

FIG. 3 is a schematic block diagram of an illustrative modular actuator assembly forming a part of the illustrative modular actuator of FIG. 1;

FIG. 4 is a schematic block diagram of an illustrative modular controller assembly forming a part of the illustrative modular actuator of FIG. 1;

FIG. 5 is a schematic block diagram of a plurality of illustrative modular actuator driver assemblies, a plurality of illustrative modular actuator assemblies and a plurality of illustrative modular controller assemblies that may be combined in a variety of different combinations in forming the illustrative modular actuator of FIG. 1;

FIGS. 6A through 6C are flow diagrams that together show an illustrative method for assembling an illustrative modular actuator such as the illustrative modular actuator of FIG. 1;

FIG. 7 is a schematic block diagram of an illustrative modular actuator;

FIG. 8 is a schematic block diagram of an illustrative modular actuator base assembly forming part of the illustrative modular actuator of FIG. 7;

FIG. 9 is a schematic block diagram of an illustrative modular control assembly forming part of the illustrative modular actuator of FIG. 7;

FIG. 10 is a schematic block diagram of a plurality of illustrative modular actuator base assemblies and a plurality of illustrative modular control assemblies that may be combined in a variety of different combinations in forming the illustrative modular actuator of FIG. 7; and

FIGS. 11A and 11B are flow diagrams that together show an illustrative method for assembling an illustrative modular actuator such as the illustrative modular actuator of FIG. 7.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

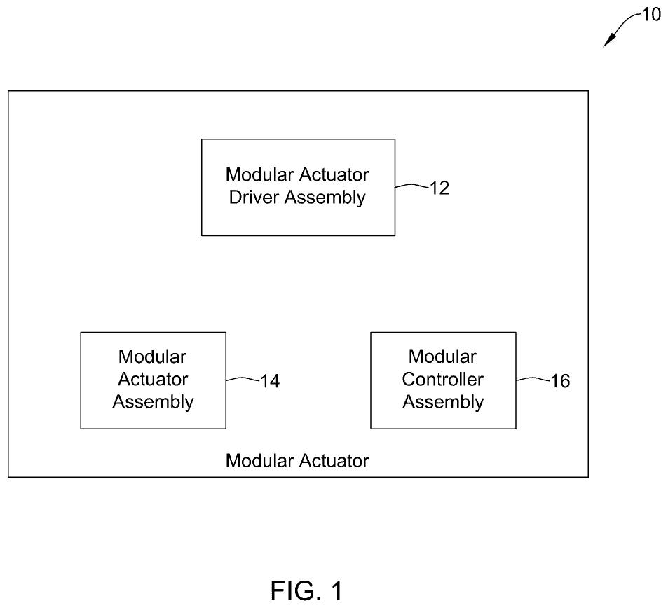

FIG. 1 is a schematic block diagram of an illustrative modular actuator 10. The illustrative modular actuator 10 may be considered as representing an actuator that may be used to open or close a damper in a Heating, Ventilating and Air Conditioning (HVAC) system, for example. The illustrative modular actuator 10 may be considered as representing an actuator that may be used to open or close a water valve, for example. The illustrative modular actuator 10 may be considered as representing an actuator that may be used to control one or more components of an industrial process. In some cases, the modular actuator 10 may represent a rotary actuator. The modular actuator 10 may represent a linear actuator. These are just examples.

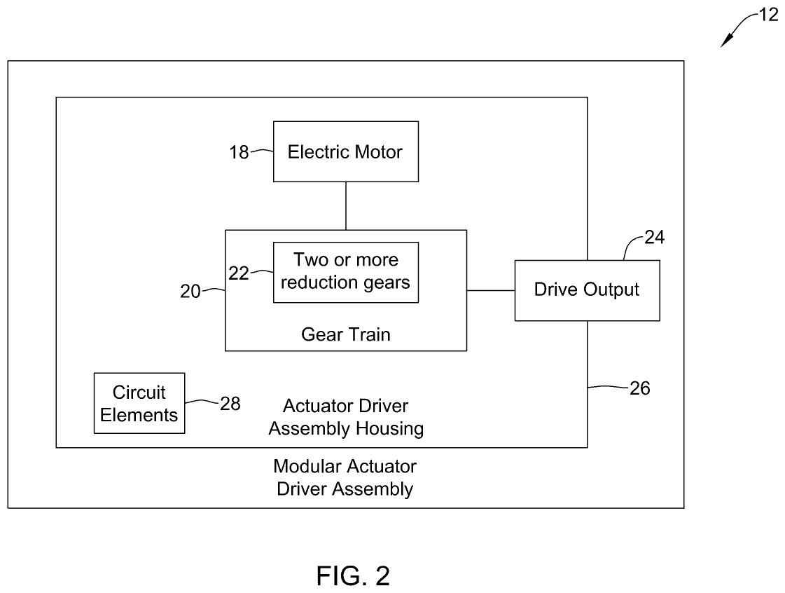

The illustrative modular actuator 10 includes a number of components that may each be chosen from multiple options for that component. The illustrative modular actuator 10 includes a modular actuator driver assembly 12 that in some cases may be selected from two, three, four, or more different modular actuator driver assemblies 12. The illustrative modular actuator 10 further includes a modular actuator assembly 14 that in some cases may be selected from two, three, four or more different modular actuator assemblies 14. The illustrative modular actuator 10 further includes a modular controller assembly 16 that in some cases may be selected from two, three, four or more different modular controller assemblies. Further details regarding the modular actuator driver assembly 12, the modular actuator assembly 14 and the modular controller assembly 16 are shown in FIGS. 2, 3 and 4, respectively.

FIG. 2 is a schematic block diagram of the illustrative modular actuator driver assembly 12. The illustrative modular actuator driver assembly 12 includes an electric motor 18 that is operably coupled to a gear train 20. The gear train 20 includes two or more reduction gears 22 that are configured to provide a decreased speed but increased torque relative to the speed and torque that is generated by the electric motor 18 itself. In some cases, the gear train 20 may include only one gear, for example. The gear train 20 is configured to drive a drive output 24 of the modular actuator driver assembly 12. An actuator driver assembly housing 26 houses the electric motor 18 and the gear train 20. The drive output 24 may be at least partially exposed by the actuator driver assembly housing 26 such that the drive output 24 may be able to engage and drive another component. The modular actuator driver assembly 12 may, as shown, include one or more circuit elements 28 that may be used to store information that describes one or more features or aspects of the modular actuator driver assembly 12 that may be accessed by another component of the modular actuator 10 in order to provide the other component with the information. In some cases, the one or more circuit elements 28 may include one or more resistors. The one or more circuit elements 28 may include one or more non-volatile memories.

In some cases, the modular actuator driver assembly 12 may be available in multiple sizes, such as a small size, a medium size and a large size. This is merely illustrative, as the modular actuator driver assembly 12 may have only one size or two sizes, or may have four, five, six or more different sizes. Each of the sizes may have a particular electric motor 18, with unique power properties such as maximum torque, maximum operating speed or varying power consumption. The electric motor 18 within a large size modular actuator driver assembly 12 may be larger, or have more available torque, than the corresponding electric motor 18 within a medium size modular actuator driver assembly 12. The electric motor 18 within a medium size modular actuator driver assembly 12 may be larger, or have more available torque, than the corresponding electric motor 18 within a small size modular actuator driver assembly 12.

Similarly, the gear train 20 may be different within each of the small modular actuator driver assembly 12, the medium modular actuator driver assembly 12 and the large modular actuator driver assembly 12. The gear train 20 within each of the small modular actuator driver assembly 12, the medium modular actuator driver assembly 12 and the large modular actuator driver assembly 12 may have different gearing, with differing reduction gears 22. The gear train 20 within some of the small modular actuator driver assembly 12, the medium modular actuator driver assembly 12 and the large modular actuator driver assembly 12 may have differing numbers of gears, for example. It will be appreciated that for a particular gear reduction between an input to the gear train 20 and an output of the gear train 20 (such as the drive output 24) may be accomplished by any of a variety of different combinations of gears, gear sizes, number of teeth on each gear, and so on.

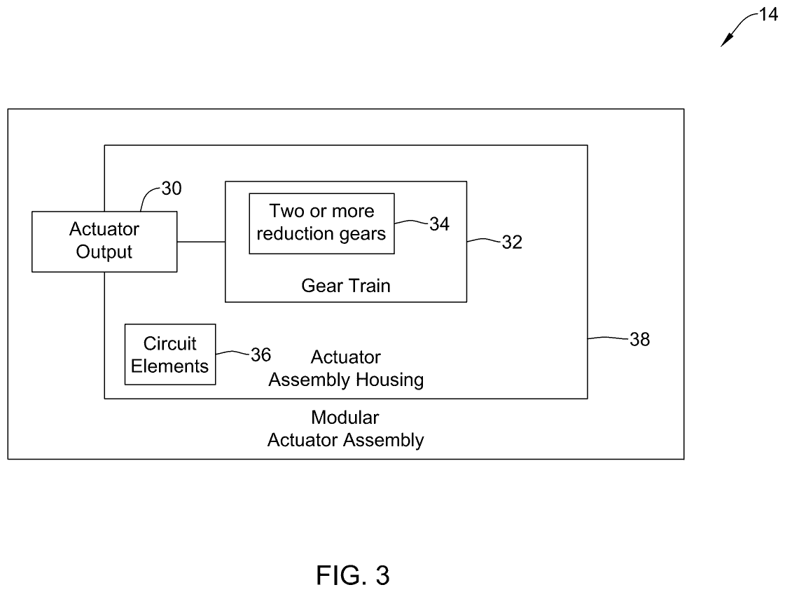

FIG. 3 is a schematic block diagram of the illustrative modular actuator assembly 14. The illustrative modular actuator assembly 14 includes an actuator output 30 that function as the actuator output of the modular actuator 10. The modular actuator assembly 14 includes a gear train 32 that has two or more reduction gears 34 for driving the actuator output 30. In some cases, the gear train 32 may only have a single gear. The gear train 32 is configured to releasably engage with the drive output 24 that is provided by the modular actuator driver assembly 12. The modular actuator assembly 14 may, as shown, include one or more circuit elements 36 that may be used to store information that describes one or more features or aspects of the modular actuator assembly 14 that may be accessed by another component of the modular actuator 10 in order to provide the other component with the information. In some cases, the one or more circuit elements 28 may include one or more resistors. The one or more circuit elements 36 may include one or more non-volatile memories.

The illustrative modular actuator assembly 14 includes an actuator assembly housing 38 that houses the gear train 32 and the one or more circuit elements 36. The actuator assembly housing 38 is configured to allow the actuator output 30 to extend beyond the actuator assembly housing 38 such that the actuator output 30 is able to engage with, or be engaged by, a shaft of a damper or a valve, or whatever the modular actuator 10 is intended to actuate. The actuator assembly housing 38 is configured to be removably mountable to the actuator driver assembly housing 26, sometimes in the field, such that the gear train 32 is operatively coupled to and driven by the exposed drive output 24 of the modular actuator driver assembly 12. For example, the actuator assembly housing 38 may be removably mountable to the actuator driver assembly housing 26 using screws, clips, snaps, clasps, clamps, pins and/or any other suitable reversable attachment mechanism that can be removed/released in the field with minimal tools (e.g. screw driver, socket, etc.) without causing damage to the actuator assembly housing 38 or the actuator driver assembly housing 26. In some cases, the same attachment mechanism (e.g. screws, clips, snaps, clasps, clamps, pins) may be re-used to removably mount a different actuator assembly housing to the actuator driver assembly housing 26 when desired.

In some cases, the modular actuator assembly 14 may be available in multiple sizes, such as a small size, a medium size and a large size. This is merely illustrative, as the modular actuator assembly 14 may have only one size or two sizes, or may have four, five, six or more different sizes. In some cases, the gear train 32 may be different within each of the small modular actuator assembly 14, the medium modular actuator assembly 14 and the large modular actuator assembly 14. The gear train 32 within each of the small modular actuator assembly 14, the medium modular actuator assembly 14 and the large modular actuator assembly 14 may have different gearing, with differing reduction gears 34. The gear train 32 within some of the small modular actuator assembly 14, the medium modular actuator assembly 14 and the large modular actuator assembly 14 may have differing numbers of gears, for example. It will be appreciated that for a particular gear reduction between an input to the gear train 32 and an output of the gear train 32 (such as the actuator output 30) may be accomplished by any of a variety of different combinations of gears, gear sizes, number of teeth on each gear, and so on.

In some cases, the modular actuator assembly 14 may be available in multiple actuator types. For example, the modular actuator assembly 14 may be a rotary actuator type that provides an actuator output that rotates about a rotation axis. Alternatively, the modular actuator assembly 14 may be a linear actuator type that provides an actuator output that moves linearly. In some cases, the modular actuator assembly 14 may be a spring return actuator type that uses the modular actuator driver assembly 12 to drive the actuator output from an initial position against a bias of a return spring, and the return spring returns the actuator output to the initial position without being driven by the modular actuator driver assembly 12. These are just examples of actuator types for the modular actuator assembly 14 that are contemplated.

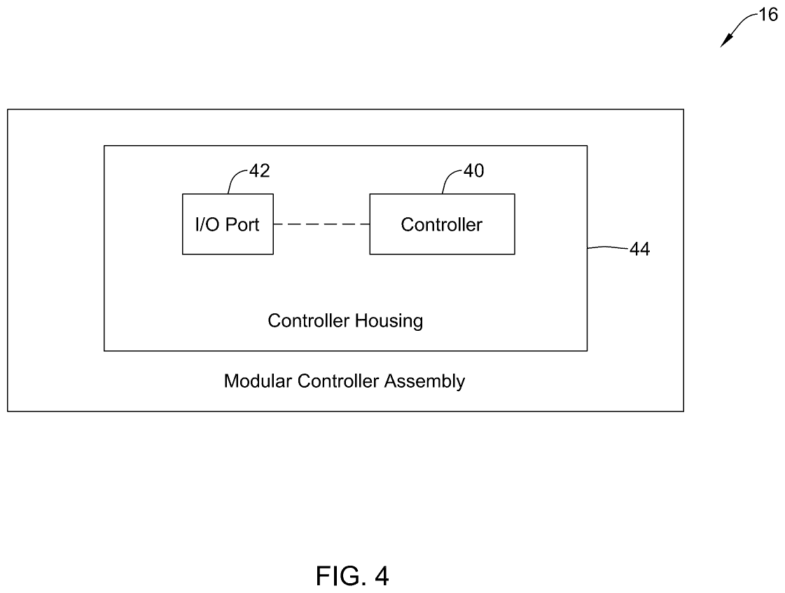

FIG. 4 is a schematic block diagram of the illustrative modular controller assembly 16. The illustrative modular controller assembly 16 includes a controller 40 that is operably coupled with an I/O port 42. The I/O port 42 may be used, for example, to receive configuration or settings information from the one or more circuit elements 28 within the modular actuator driver assembly 12 and/or the one or more circuit elements 36 within the modular actuator assembly 14, when present. In some cases, resistance varies with torque, and the modular controller assembly 16 may be configured to determine the torque of modular actuator driver assembly 12 by sampling a resistance value. In addition, or alternatively, the I/O port 42 may be used to receive operational commands from a system employing the modular actuator 10, for example. The I/O port 42 may operate in accordance with any desired wired or wireless communication protocol. For example, the I/O port 42 may utilize Bluetooth wireless communication. This is just an example.

The illustrative modular controller assembly 16 has a controller housing 44 that houses the controller 40 and the I/O port 42, although in some cases the I/O port 42 may be physically accessible from exterior to the controller housing 44. The controller housing 44 may be removably mountable to the actuator driver assembly housing 26 and/or the actuator assembly housing 38 in the field, meaning subsequent to manufacture of the modular actuator 10. For example, the controller housing 44 may be removably mountable to the actuator driver assembly housing 26 and/or the actuator assembly housing 38 using screws, clips, snaps, clasps, clamps, pins and/or any other suitable reversable attachment mechanism that can be removed/released in the field with minimal tools (e.g. screw driver, socket, etc.) without causing damage to the controller housing 44, the actuator driver assembly housing 26 and/or the actuator assembly housing 38. In some cases, the same attachment mechanism (e.g. screws, clips, snaps, clasps, clamps, pins) may be re-used to removably mount a different controller housing 44 to the actuator driver assembly housing 26 and/or the actuator assembly housing 38 when desired.

The controller 40 may be configured to control operation of the electric motor 18 of the modular actuator driver assembly 12, and thus the controller 40 may be configured to control the actuator output 30 of the modular actuator 10 through the gear train 20 (of the modular actuator driver assembly 12) and the gear train 32 (of the modular actuator assembly 14).

In some cases, the modular controller assembly 16 may be available having a variety of different functionalities. For example, one model of the modular controller assembly 16 may be programmed with a first communication protocol while another model of the modular controller assembly 16 may be programmed with a second communication protocol that is different from the first communication protocol. An operator may wish to replace an installed modular controller assembly 16 that is programmed with the first communication protocol with a replacement modular controller assembly that is programmed with the second communication protocol if the system in which the modular actuator 10 is installed is upgrading its communication protocol. This means that the installed modular actuator 10 does not need to be replaced in its entirety, but merely needs a different modular controller assembly 16 to be installed.

In some cases, a different modular controller assembly 16 may be configured to implement a different control algorithm, and there may be a desire to be able to implement a different control algorithm. As another example, a different modular controller assembly 16 may be configured to receive one or more inputs (e.g. sensor inputs and/or control inputs) that a currently installed modular controller assembly 16 is not configured to receive. By replacing the currently installed modular controller assembly 16 with the different modular controller assembly 16 that is configured to receive the one or more additional inputs, the different modular controller assembly 16 is able to control operation of the modular actuator 10 using the one or more new additional inputs.

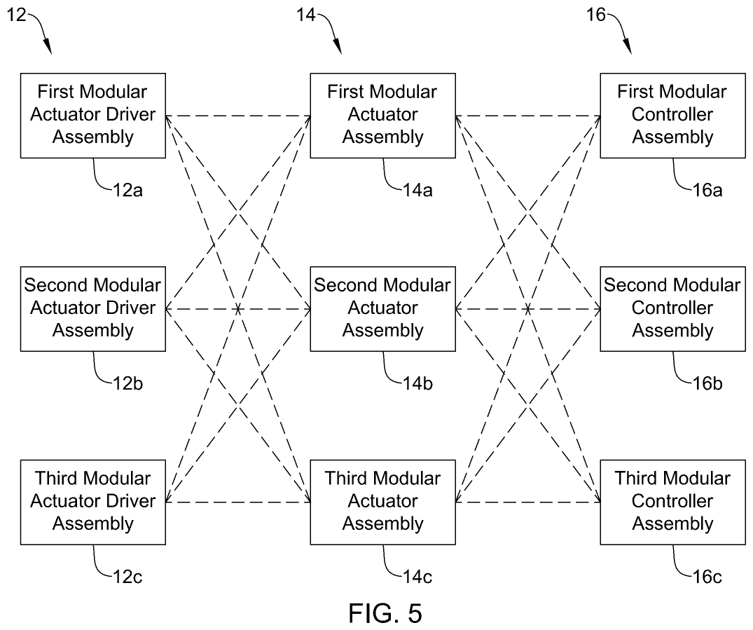

FIG. 5 is a schematic block diagram of a plurality of illustrative modular actuator driver assemblies 12, a plurality of illustrative modular actuator assemblies 14, and a plurality of illustrative modular controller assemblies 16. The plurality of modular actuator driver assemblies 12 includes a first modular actuator driver assembly 12a, a second modular actuator driver assembly 12b and a third modular actuator driver assembly 12c. The plurality of modular actuator assemblies 14 include a first modular actuator assembly 14a, a second modular actuator assembly 14b and a third modular actuator assembly 14c. The plurality of modular controller assemblies 16 includes a first modular controller assembly 16a, a second modular controller assembly 16b and a third modular controller assembly 16c.

While a total of three modular actuator driver assemblies 12, a total of three modular actuator assemblies 14 and a total of three modular controller assemblies 16 are shown, it will be appreciated that this is merely illustrative, as there may be one, two, four or more modular actuator driver assemblies 12. There may be one, two, four or more modular actuator assemblies 14. There may be one, two, four or more modular controller assemblies 16. Depending on the desired characteristics of the modular actuator 10, a particular one of the modular actuator driver assemblies 12 may be combined with a particular one of the modular actuator assemblies 14 and a particular one of the modular controller assemblies 16. As an example, the second modular actuator driver assembly 12b may be combined with the third modular actuator assembly 14c and the first modular controller assembly 16a. It will be appreciated that there are a number of possible permutations.

With respect to notation, it may be considered that the first modular actuator driver assembly 12a includes a first gear train 20 and the first modular actuator assembly 14a includes a second gear train 32. The second modular actuator driver assembly 12b may include a third gear train while the second modular actuator assembly 14b may include a fourth gear train. The third modular actuator driver assembly 12c may include a fifth gear train while the third modular actuator assembly 14c may include a sixth gear train. Alternatively, the first modular actuator driver assembly 12a may include a first gear train, the second modular actuator driver assembly 12b may include a second gear train, and so on. Reference to first gear train, second gear train, third gear train and so on, or reference to first, second, third with respect to any of the modular actuator driver assemblies 12, the modular actuator assemblies 14 or the modular controller assemblies 16 is arbitrary. In the example shown, each of the modular actuator driver assemblies 12 has its own gear train, regardless of how it is referenced. Each of the modular actuator assemblies 14 has its own gear train, regardless of how it is referenced.

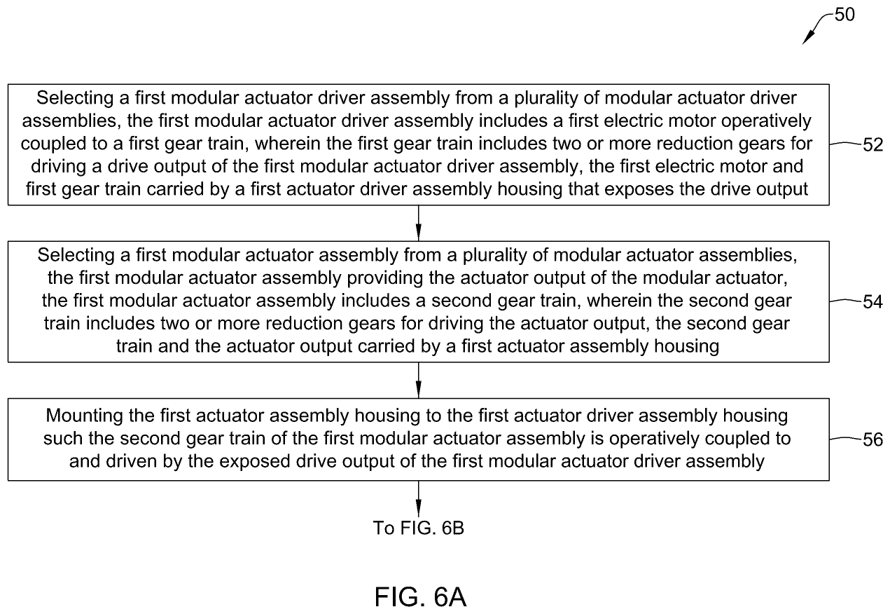

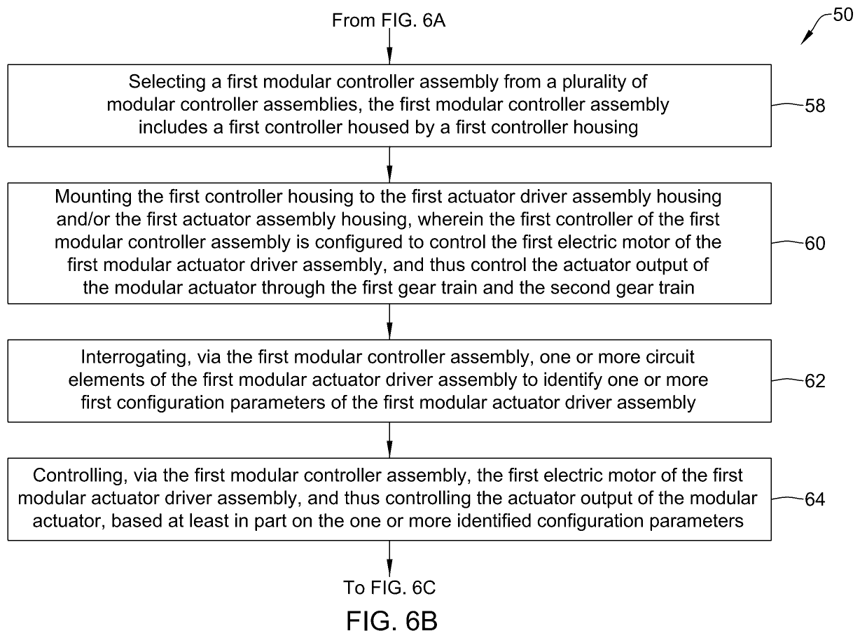

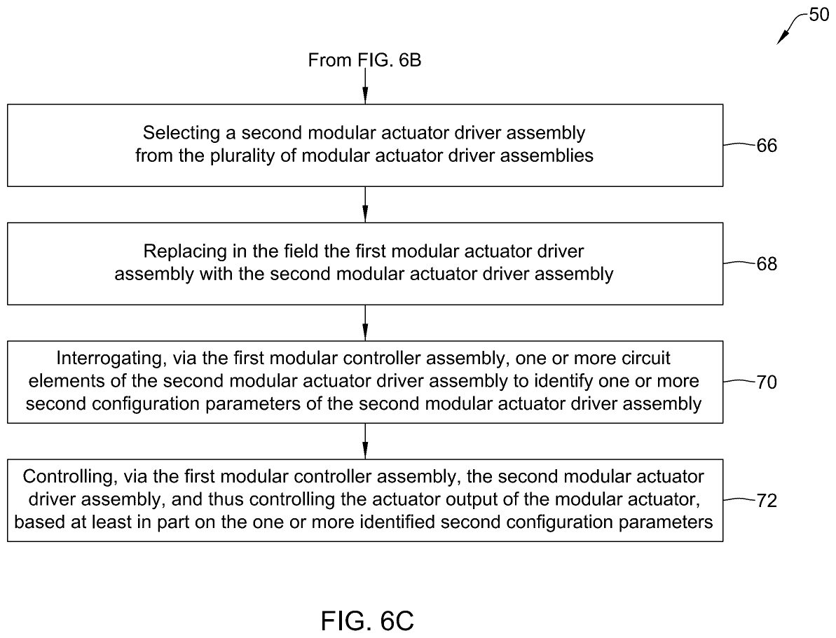

FIGS. 6A through 6C are flow diagrams that together show an illustrative method 50 for assembling a modular actuator (such as the modular actuator 10) having an actuator output (such as the actuator output 30). The illustrative method 50 includes selecting a first modular actuator driver assembly from a plurality of modular actuator driver assemblies, the first modular actuator driver assembly including a first electric motor operatively coupled to a first gear train, wherein the first gear train includes two or more reduction gears for driving a drive output of the first modular actuator driver assembly. The first electric motor and first gear train are carried by a first actuator driver assembly housing that exposes the drive output, as indicated at block 52. A first modular actuator assembly is selected from a plurality of modular actuator assemblies. The first modular actuator assembly providing the actuator output of the modular actuator. The first modular actuator assembly includes a second gear train, wherein the second gear train includes two or more reduction gears for driving the actuator output. The second gear train and the actuator output are carried by a first actuator assembly housing, as indicated at block 54. The first actuator assembly housing is mounted relative to the first actuator driver assembly housing such the second gear train of the first modular actuator assembly is operatively coupled to and driven by the exposed drive output of the first modular actuator driver assembly, as indicated at block 56.

Continuing on FIG. 6B, the method 50 may include selecting a first modular controller assembly from a plurality of modular controller assemblies, the first modular controller assembly includes a first controller housed by a first controller housing, as indicated at block 58. The first controller housing is mounted to the first actuator driver assembly housing and/or the first actuator assembly housing, wherein the first controller of the first modular controller assembly is configured to control the first electric motor of the first modular actuator driver assembly, and thus control the actuator output of the modular actuator through the first gear train and the second gear train, as indicated at block 60. In some cases, the illustrative method 50 may include interrogating, via the first modular controller assembly, one or more circuit elements of the first modular actuator driver assembly to identify one or more first configuration parameters of the first modular actuator driver assembly, as indicated at block 62. The configuration parameters may include, for example, maximum motor current allowed, maximum torque, maximum range of motion, maximum operating speed, type of output (rotary, linear), type and number of sensor outputs (e.g. end stop detection, position detection, power draw, diagnostic information, etc.), type(s) of communication protocols, type(s) of commands that can be received executed, type(s) of control algorithms that can be executed, type(s) of feedback provided, as well as any other suitable configuration parameters. In some cases, the method 50 may further include controlling, via the first modular controller assembly, the first electric motor of the first modular actuator driver assembly, and thus controlling the actuator output of the modular actuator, based at least in part on the one or more identified configuration parameters, as indicated at block 64.

Continuing on FIG. 6C, the illustrative method 50 may include selecting a second modular actuator driver assembly from the plurality of modular actuator driver assemblies, as indicated at block 66. The first modular actuator driver assembly is replaced, sometimes in the field, with the second modular actuator driver assembly, as indicated at block 68. One or more circuit elements of the second modular actuator driver assembly are interrogated via the first modular controller assembly to identify one or more second configuration parameters of the second modular actuator driver assembly, as indicated at block 70. The illustrative method 50 may include controlling, via the first modular controller assembly, the second modular actuator driver assembly, and thus controlling the actuator output of the modular actuator, based at least in part on the one or more identified second configuration parameters, as indicated at block 72.

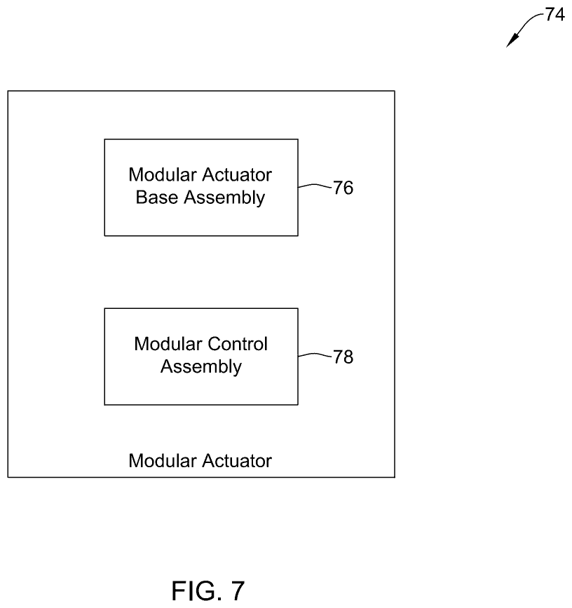

FIG. 7 is a schematic block diagram of an illustrative modular actuator 74. The illustrative modular actuator 74 may be considered as representing an actuator that may be used to open or close a damper in a Heating, Ventilating and Air Conditioning (HVAC) system, for example. The illustrative modular actuator 74 may be considered as representing an actuator that may be used to open or close a water valve, for example. The illustrative modular actuator 74 may be considered as representing an actuator that may be used to control one or more components of an industrial process. In some cases, the modular actuator 74 may represent a rotary actuator. The modular actuator 74 may represent a linear actuator. These are just examples.

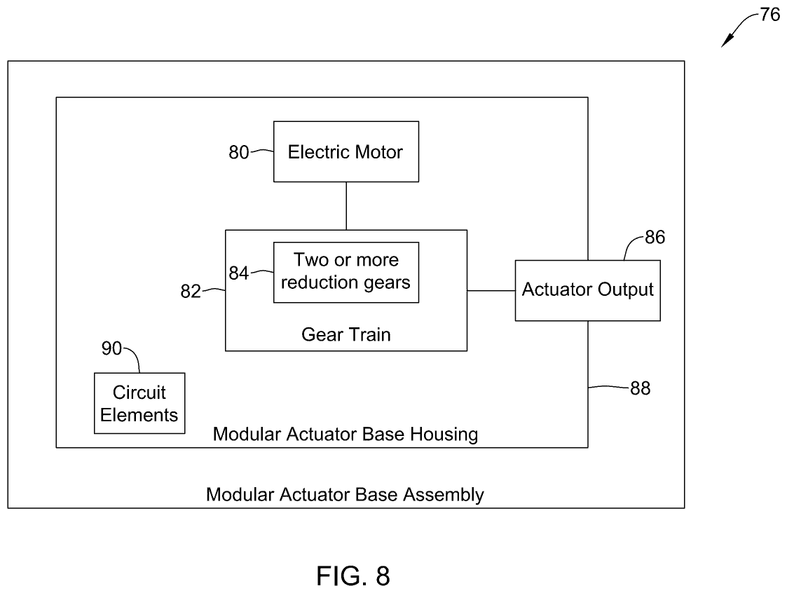

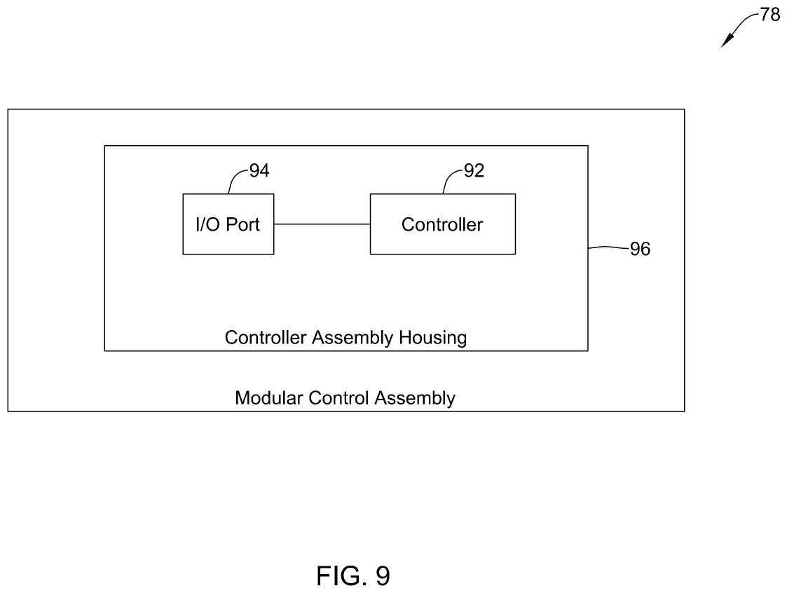

The illustrative modular actuator 74 includes several components that may each be chosen from multiple options for that component. The illustrative modular actuator 74 includes a modular actuator base assembly 76 that in some cases may be selected from two, three, four, or more different modular actuator base assemblies 76. The illustrative modular actuator 74 further includes a modular control assembly 78 that in some cases may be selected from two, three, four or more different modular control assemblies 78. Further details regarding the modular actuator base assembly 76 and the modular control assembly 78 are shown in FIGS. 8 and 9, respectively.

FIG. 8 is a schematic block diagram of the illustrative modular actuator base assembly 76. The illustrative modular actuator base assembly 76 includes an electric motor 80 that is operably coupled to a gear train 82. The gear train 82 includes two or more reduction gears 84 that are configured to provide a decreased speed but increased torque relative to the speed and torque that is generated by the electric motor 80 itself. In some cases, the gear train 82 may include only one gear, for example. The gear train 82 is configured to drive an actuator output 86. An modular actuator base housing 88 houses the electric motor 80 and the gear train 82. The actuator output 86 may be at least partially exposed by the modular actuator base housing 88 such that the actuator output 86 may be able to engage and drive another component (e.g. damper or valve shaft). The modular actuator base assembly 76 may, as shown, include one or more circuit elements 90 that may be used to store information that describes one or more features or aspects of the modular actuator base assembly 76 that may be accessed by another component of the modular actuator 74 in order to provide the other component with the information. In some cases, the one or more circuit elements 90 may include one or more resistors. The one or more circuit elements 90 may include one or more non-volatile memories. The component information may include, for example, maximum motor current allowed, maximum torque, maximum range of motion, maximum operating speed, type of output (rotary, linear), type and number of sensor outputs (e.g. end stop detection, position detection, power draw, diagnostic information, etc.), type(s) of communication protocols, type(s) of commands that can be received executed, type(s) of control algorithms that can be executed, type(s) of feedback provided, as well as any other suitable component information.

In some cases, the modular actuator base assembly 76 may be available in multiple sizes, such as a small size, a medium size and a large size. This is merely illustrative, as the modular actuator base assembly 76 may have only one size or two sizes, or may have four, five, six or more different sizes. Each of the sizes may have a particular electric motor 80, with unique power properties such as maximum torque, maximum operating speed or varying power consumption. The electric motor 80 within a large size modular actuator base assembly 76 may be larger, or have more available torque, than the corresponding electric motor 80 within a medium size modular actuator base assembly 76. The electric motor 80 within a medium size modular actuator base assembly 76 may be larger, or have more available torque, than the corresponding electric motor 80 within a small size modular actuator base assembly 76.

Similarly, the gear train 82 may be different within each of the small modular actuator base assembly 76, the medium modular actuator base assembly 76 and the large modular actuator base assembly 76. The gear train 82 within each of the small modular actuator base assembly 76, the medium modular actuator base assembly 76 and the large modular actuator base assembly 76 may have different gearing, with differing reduction gears 84. The gear train 82 within some of the small modular actuator base assembly 76, the medium modular actuator base assembly 76 and the large modular actuator base assembly 76 may have differing numbers of gears, for example. It will be appreciated that for a particular gear reduction between an input to the gear train 82 and an output of the gear train 84 (such as the actuator output 86) may be accomplished by any of a variety of different combinations of gears, gear sizes, number of teeth on each gear, and so on.

FIG. 9 is a schematic block diagram of the illustrative modular control assembly 78. The illustrative modular control assembly 78 includes a controller 92 that is operably coupled with an I/O port 94. The I/O port 94 may be used, for example, to receive configuration or settings information from the one or more circuit elements 90 within the modular actuator base assembly 76, when present. In some cases, resistance varies with torque, and the modular control assembly 78 may be configured to determine the torque of the modular actuator base assembly 76 by sampling a resistance value. In addition, or alternatively, the I/O port 94 may be used to receive operational commands from a system employing the modular actuator 74, such as a Building Management System (BMS) for example. The I/O port 94 may operate in accordance with any desired wired or wireless communication protocol. For example, the I/O port 94 may utilize Bluetooth wireless communication. This is just an example. The I/O port may also be used to connect to a controller (when present) and/or one or more sensors (when present) of the modular actuator base assembly 76 to monitor and/or control the operation of the modular actuator base assembly 76.

The illustrative modular control assembly 78 has a control assembly housing 96 that houses the controller 92 and the I/O port 94, although in some cases the I/O port 94 may be physically accessible from exterior to the control assembly housing 96. The control assembly housing 96 may be removably mountable to the modular actuator base housing 88 in the field, meaning subsequent to manufacture of the modular actuator 74. For example, the control assembly housing 96 may be removably mountable to the modular actuator base housing 88 using screws, clips, snaps, clasps, clamps, pins and/or any other suitable reversable attachment mechanism that can be removed/released in the field with minimal tools (e.g. screw driver, socket, etc.) without causing damage to the control assembly housing 96 or the modular actuator base housing 88. In some cases, the same attachment mechanism (e.g. screws, clips, snaps, clasps, clamps, pins) may be re-used to removably mount a different control assembly housing to the modular actuator base housing 88 when desired.

The controller 92 may be configured to control operation of the electric motor 80 of the modular actuator base assembly 76, and thus the controller 92 may be configured to control the actuator output 86 of the modular actuator 74 through the gear train 82.

In some cases, the modular control assembly 78 may be available having a variety of different functionalities. For example, one model of the modular control assembly 78 may be programmed with a first communication protocol while another model of the modular control assembly 78 may be programmed with a second communication protocol that is different from the first communication protocol. An operator may wish to replace an installed modular control assembly 78 that is programmed with the first communication protocol with a replacement modular control assembly 78 that is programmed with the second communication protocol if the system in which the modular actuator 74 is installed is upgrading its communication protocol. This means that the installed modular actuator 74 does not need to be replaced in its entirety, but merely needs a different modular control assembly 78 to be installed.

In some cases, a different modular control assembly 78 may be configured to implement a different control algorithm, and there may be a desire to be able to implement a different control algorithm. As another example, a different modular control assembly 78 may be configured to receive one or more inputs (e.g. sensor inputs and/or control inputs) that a currently installed modular control assembly 78 is not configured to receive. By replacing the currently installed modular control assembly 78 with the different modular control assembly 78 that is configured to receive the one or more additional inputs, the different modular control assembly 78 is able to control operation of the modular actuator 74 using the one or more new additional inputs.

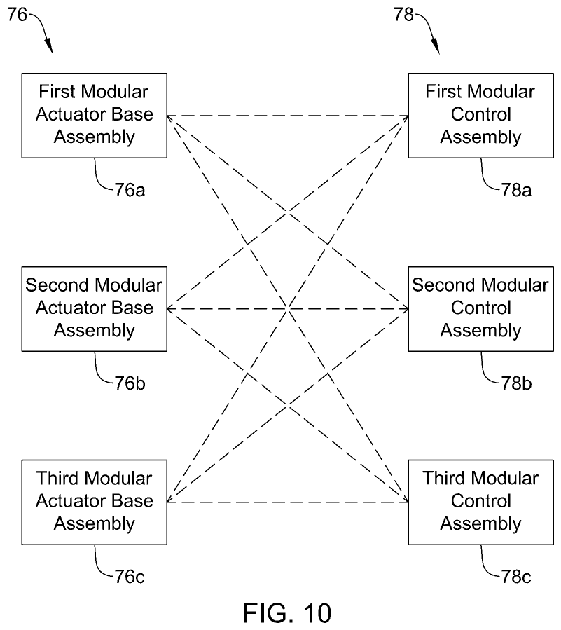

FIG. 10 is a schematic block diagram of a plurality of illustrative modular actuator base assemblies 76 and a plurality of illustrative modular control assemblies 78. The plurality of modular actuator base assemblies 76 includes a first modular actuator base assembly 76a, a second modular actuator base assembly 76b and a third modular actuator base assembly 76c. The plurality of modular control assemblies 78 includes a first modular control assembly 78a, a second modular control assembly 78b and a third modular control assembly 78c.

While a total of three modular actuator base assemblies 76 and a total of three modular control assemblies 78 are shown, it will be appreciated that this is merely illustrative, as there may be one, two, four or more modular actuator base assemblies 76. There may be one, two, four or more modular control assemblies 78. Depending on the desired characteristics of the modular actuator 74, a particular one of the modular actuator base assemblies 76 may be combined with a particular one of the modular control assemblies 78. As an example, the second modular actuator base assembly 76b may be combined with the first modular control assembly 78a. It will be appreciated that there are a number of possible permutations.

With respect to notation, it may be considered that the first modular actuator base assembly 76a includes a first gear train 82. The second modular actuator base assembly 76b may include a second gear train. The third modular actuator base assembly 76c may include a third gear train. Reference to first gear train, second gear train, third gear train and so on, or reference to first, second, third with respect to any of the modular actuator base assemblies 76 or the modular control assemblies 78 is arbitrary. In the example shown, each of the modular actuator base assemblies 76 has its own gear train, regardless of how it is referenced.

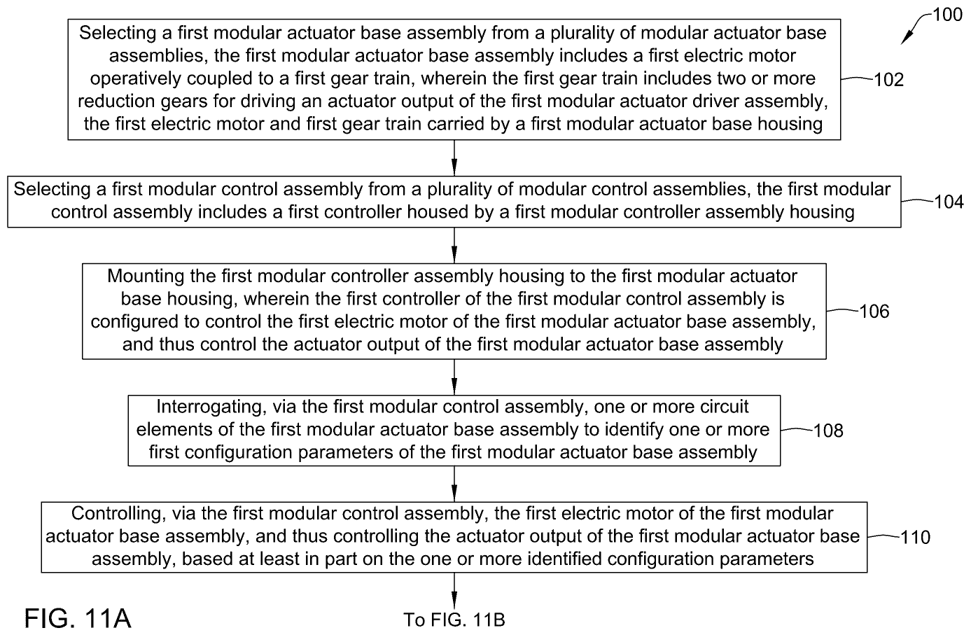

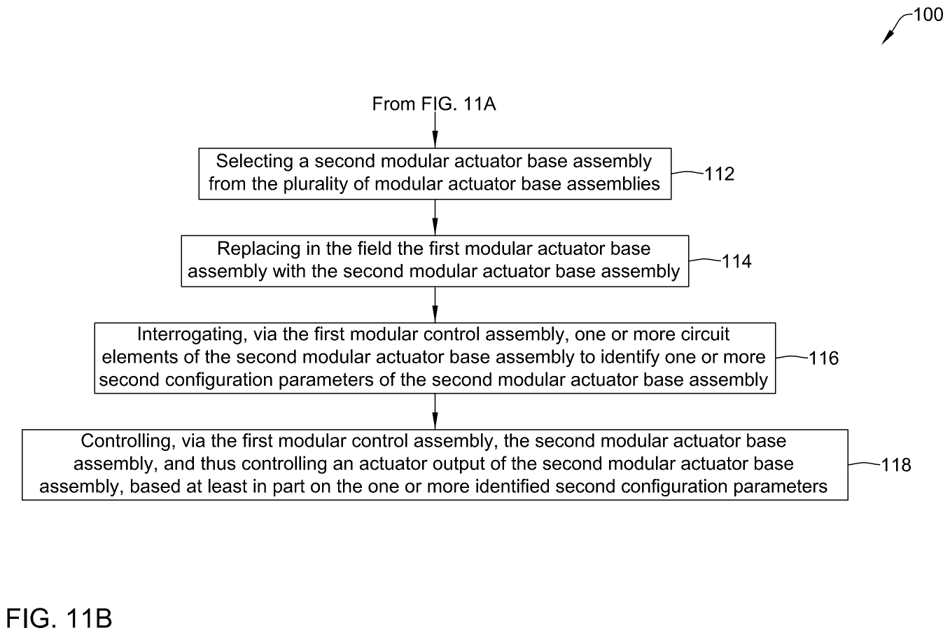

FIGS. 11A and 11B are flow diagrams that together show an illustrative method 100 for assembling a modular actuator (such as the modular actuator 74) having an actuator output (such as the actuator output 86). The illustrative method 100 includes selecting a first modular actuator base assembly from a plurality of modular actuator base assemblies. In this example, the first modular actuator base assembly includes a first electric motor operatively coupled to a first gear train, wherein the first gear train includes two or more reduction gears for driving an actuator output of the first modular actuator base assembly. The first electric motor and first gear train are carried by a first modular actuator base housing, as indicated at block 102. A first modular control assembly is selected from a plurality of modular control assemblies. The first modular control assembly includes a first controller housed by a first modular controller assembly housing, as indicated at block 104. The first modular controller assembly housing is removably mounted to the first modular actuator base housing, wherein the first controller of the first modular control assembly is configured to control the first electric motor of the first modular actuator base assembly, and thus control the actuator output of the first modular actuator base assembly, as indicated at block 106.

In some cases, the method 100 further includes interrogating, via the first modular control assembly, one or more circuit elements of the first modular actuator base assembly to identify one or more first configuration parameters of the first modular actuator base assembly, as indicated at block 108. The configuration parameters may include, for example, maximum motor current allowed, maximum torque, maximum range of motion, maximum operating speed, type of output (rotary, linear), type and number of sensor outputs (e.g. end stop detection, position detection, power draw, diagnostic information, etc.), type(s) of communication protocols, type(s) of commands that can be received executed, type(s) of control algorithms that can be executed, type(s) of feedback provided, as well as any other suitable configuration parameters. The method 100 may further include controlling, via the first modular control assembly, the first electric motor of the first modular actuator base assembly, and thus controlling the actuator output of the first modular actuator base assembly, based at least in part on the one or more identified configuration parameters, as indicated at block 110.

The method 100 continues on FIG. 11B, and includes selecting a second modular actuator base assembly from the plurality of modular actuator base assemblies, as indicated at block 112. The first modular actuator base assembly is replaced in the field with the second modular actuator base assembly, as indicated at block 114. The method 100 may include interrogating, via the first modular control assembly, one or more circuit elements of the second modular actuator base assembly to identify one or more second configuration parameters of the second modular actuator base assembly, as indicated at block 116. The method 100 may include controlling, via the first modular control assembly, the second modular actuator base assembly, and thus controlling an actuator output of the second modular actuator base assembly, based at least in part on the one or more identified second configuration parameters, as indicated at block 118.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A modular actuator that is configurable in the field, the modular actuator configured to drive an actuator output, the modular actuator comprising:
a first modular actuator base assembly providing the actuator output of the modular actuator, the first modular actuator base assembly comprising:
a first modular actuator base housing;
a first electric motor operatively coupled to a first gear train, wherein the first gear includes two or more reduction gears for driving the actuator output, the first electric motor and the first gear train carried by the first modular actuator base housing;
a first modular control assembly, the first modular control assembly comprising:
a first control assembly housing;
a first controller carried by the first control assembly housing;
wherein the first control assembly housing is removable mountable to the first modular actuator base housing in the field; and
wherein the first controller is configured to control the first electric motor of the first modular actuator base assembly, and thus control the actuator output of the modular actuator through the first gear train.

2. The modular actuator of claim 1, wherein the first modular actuator base assembly is field replaceable with a second modular actuator base assembly, wherein the second modular actuator base assembly when installed provides the actuator output of the modular actuator, the second modular actuator base assembly includes a second gear train, wherein the second gear train includes two or more reduction gears for driving the actuator output of the modular actuator, the second gear train and the actuator output carried by a second modular actuator base housing.

3. The modular actuator of claim 2, wherein the second modular actuator base housing is field-attachable to the first control assembly housing.

4. The modular actuator of claim 2, wherein the first modular actuator base assembly implements a rotatory actuator output for the modular actuator, and the second modular actuator base assembly implements a linear actuator output for the modular actuator.

5. The modular actuator of claim 2, wherein the second modular actuator base assembly is capable of providing more peak torque to the actuator output of the modular actuator than the first modular actuator base assembly.

6. The modular actuator of claim 1, wherein the first modular control assembly is field replaceable with a second modular control assembly, wherein the second modular control assembly includes a second controller housed by a second controller housing, the second modular control assembly implements at least one different functionality relative to the first modular control assembly, the second controller housing is removably mountable to the first modular actuator base housing in the field in place of the first modular control assembly, wherein the second controller of the second modular control assembly is configured to control the first electric motor of the first modular actuator base assembly, and thus control the actuator output of the modular actuator through the first gear train.

7. The modular actuator of claim 6, wherein the at least one different functionality comprises support for a different communication protocol for communicating with an external device.

8. The modular actuator of claim 6, wherein the at least one different functionality comprises one or more different control algorithms for controlling the modular actuator.

9. The modular actuator of claim 6, wherein the at least one different functionality comprises receiving one or more additional inputs, and controlling the modular actuator based at least in part on one or more of the additional inputs.

10. The modular actuator of claim 1, wherein the first modular actuator base assembly comprises one or more circuit elements that when interrogated identify one or more configuration parameters of the first modular actuator base assembly, and wherein the first modular control assembly is configured to interrogate one or more of the circuit elements to identify one or more of the configuration parameters and control the first electric motor of the first modular actuator base assembly, and thus control the actuator output of the modular actuator, based at least in part on the one or more identified configuration parameters.

11. The modular actuator of claim 10, wherein the one or more circuit elements comprise one or more resistors.

12. The modular actuator of claim 10, wherein the one or more circuit elements comprise one or more non-volatile memories.

13. A modular actuator configured to drive an actuator output, the modular actuator comprising:
a first modular actuator base assembly providing the actuator output of the modular actuator, the first modular actuator base assembly comprising:
a first modular actuator base housing;
a first electric motor operatively coupled to a first gear train, wherein the first gear train includes two or more reduction gears for driving the actuator output, the first electric motor and the first gear train carried by the first modular actuator base housing;
a first modular control assembly, the first modular control assembly comprising:
a first control assembly housing;
a first controller carried by the first control assembly housing;
wherein the first control assembly housing is removable mountable to the first modular actuator base housing in the field; and
wherein the first controller is configured to control the first electric motor of the first modular actuator base assembly, and thus control the actuator output of the modular actuator through the first gear train;
wherein the first modular actuator base assembly comprises one or more circuit elements that when interrogated identify one or more configuration parameters of the first modular actuator base assembly, and wherein the first modular control assembly is configured to interrogate one or more of the circuit elements to identify one or more of the configuration parameters and control the first electric motor of the first modular actuator base assembly, and thus control the actuator output of the modular actuator, based at least in part on the one or more identified configuration parameters.

14. The modular actuator of claim 13, wherein the one or more circuit elements comprise one or more resistors.

15. The modular actuator of claim 13, wherein the one or more circuit elements comprise one or more non-volatile memories.

16. The modular actuator of claim 13, wherein the first modular actuator base assembly is replaceable with a second modular actuator base assembly, wherein the second modular actuator base assembly includes a second electric motor operatively coupled to a second gear train, wherein the second gear train includes two or more reduction gears for driving the actuator output of the modular actuator, the second electric motor and the second gear train carried by a second actuator driver base housing.

17. The modular actuator of claim 13, wherein the first modular control assembly is field replaceable with a second modular control assembly, wherein the second modular control assembly includes a second controller housed by a second controller housing, the second modular control assembly implements at least one different functionality relative to the first modular control assembly, the second controller housing is removably mountable to the first modular actuator base housing in the field in place of the first modular control assembly, wherein the second controller of the second modular control assembly is configured to control the first electric motor of the first modular actuator base assembly, and thus control the actuator output of the modular actuator through the first gear train.

18. A method for assembling a modular actuator having an actuator output, the method comprising:
selecting a first modular actuator base assembly from a plurality of modular actuator base assemblies, the first modular actuator base assembly including a first electric motor operatively coupled to a first gear train, wherein the first gear train includes two or more reduction gears for driving an actuator output of the first modular actuator base assembly, the first electric motor and first gear train carried by a first modular actuator base housing;
selecting a first modular control assembly from a plurality of modular control assemblies, the first modular control assembly includes a first controller housed by a first modular controller assembly housing; and
removably mounting the first modular controller assembly housing to the first modular actuator base housing, wherein the first controller of the first modular control assembly is configured to control the first electric motor of the first modular actuator base assembly, and thus control the actuator output of the first modular actuator base assembly.

19. The method of claim 18, further comprising:
interrogating, via the first modular control assembly, one or more circuit elements of the first modular actuator base assembly to identify one or more first configuration parameters of the first modular actuator base assembly; and
controlling, via the first modular control assembly, the first electric motor of the first modular actuator base assembly, and thus controlling the actuator output of the first modular actuator base assembly, based at least in part on the one or more identified configuration parameters.

20. The method of claim 19, further comprising:
selecting a second modular actuator base assembly from the plurality of modular actuator base assemblies;
replacing in the field the first modular actuator base assembly with the second modular actuator base assembly;
interrogating, via the first modular control assembly, one or more circuit elements of the second modular actuator base assembly to identify one or more second configuration parameters of the second modular actuator base assembly; and
controlling, via the first modular control assembly, the second modular actuator base assembly, and thus controlling an actuator output of the second modular actuator base assembly, based at least in part on the one or more identified second configuration parameters.
